(19) United States
(12) Patent Application Publication
(10) Pub. No.: US 2015/0110268 A1
(43) Pub. Date: Apr. 23, 2015

(54) METHOD FOR CODING AND DECODING INFORMATION ASSOCIATED WITH AN ITEM

(71) Applicant: NICANTI Oy, Helsinki (FI)

(72) Inventor: Paul Peter Wilkinson, Faloppio (IT)

(21) Appl. No.: 14/385,743

(22) PCT Filed: Mar. 15, 2013
(86) PCT No.: PCT/IB2013/052072

§ 371 Date: Sep. 16, 2014

(30) Foreign Application Priority Data
Mar. 16, 2012 (IT) TO2012A000231

(51) Int. Cl. H04L 9/08

(52) U.S. Cl. CPC H04L 9/0816; H04L 9/0869; H04L 2209/24
USPC 380/46; 380/44

(57) ABSTRACT

A method for coding and decoding information (10) associated with an item includes the steps of coding the information (10) associated with the item through an encryption key (20) and a first encryption algorithm, so as to generate a code (50) associated with the information (10), the code being realized through at least one material, typically an ink, having predefined electric properties (30) and being readable and decryptable by applying a variable electric field, and of applying the code (50) to the item, wherein the method generates encrypted information (95) which can be obtained by encrypting variable information (70) through a second encryption algorithm which uses, as an encryption key, the information (10) associated with the item, and applies the variable information (70) to the item or to a second item associated with the item.

The present invention relates to the field of methods for generating and reading a machine-readable code (MRC).

More in particular, the present invention relates to a method for coding information associated with an item by applying an encrypted code to said item.

Printed codes are known in the art which are applied to an item so that it can be identified and/or traced.

International patent applications no. WO 2009/138571 and no. WO 2011/114266 are known methods for generating a code by exploiting electric properties of inks or other materials, for the purpose of entering into said code digital information that can only be extracted by authorized users and of making the code more difficult to clone or copy.

Cloning a code means to reproduce a code without knowing the logic that generated it; copying a code means to reproduce a code when the generation logic thereof is known. According to the above-mentioned international patent applications, the code is read by analyzing how the various elements arranged in sequence in the code made in accordance with said method react to radio frequency.

Moreover, international patent application no. WO 2009/138571 describes an electronic circuit built into a scanner which is used for disassembling into a real component and an imaginary component the current generated within the ink by radio-frequency excitation.

Electrodes are used to generate an alternating (or anyway non-constant) electric field and then, again by using said electrodes, the current or voltage in response to said electric field is measured. By varying the electric properties of the elements that make up the code, it is possible to vary the response to the induced electric field, and hence to create a readable and decryptable code.

Compared to other systems for reading codes having electric properties, the method described in the above-mentioned international patent application also ensures higher reading reliability. This is due to the quality of the signal provided by analyzing the electric properties of the materials used for creating the code, as well as to the capability of obtaining said signal even when the code is read without contact, i.e. from the back side of the substrate onto which the code has been applied, or through a graphic decoration layer, or through a protection layer against external agents, or, more simply, when absence of contact is caused by roughness of the substrate on which the code has been printed.

The Applicant has developed a system for generating printed coded by using inks or other materials having known electric properties.

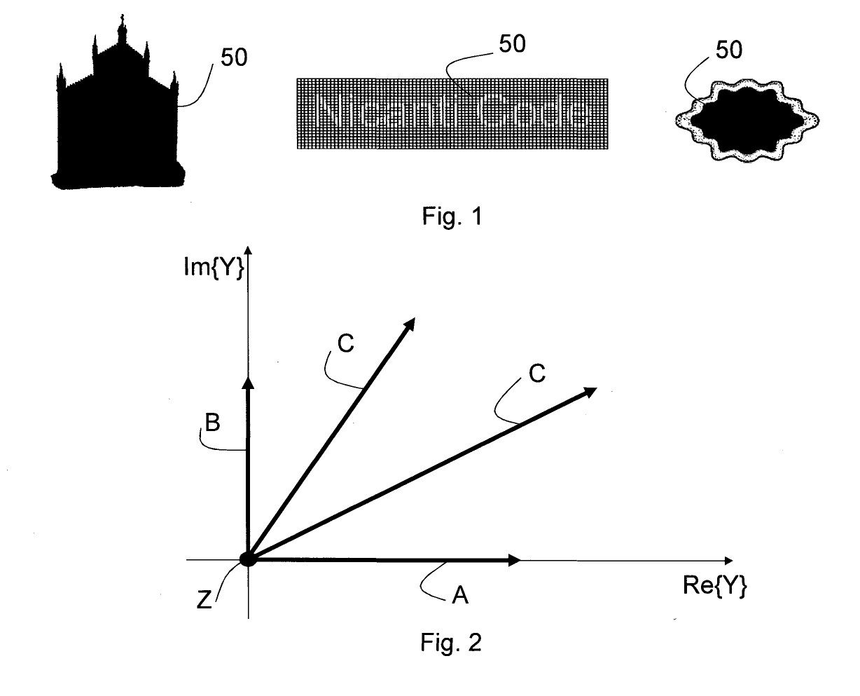

The appearance of the codes thus generated may vary, but the most important thing is that they, while still containing different digital information, can be visually indistinguishable from one another. One example of such codes is shown in FIG. 1.

A visually indistinguishable code is an applied code which cannot be distinguished from other similar codes, although the information it contains is different from that of other similar codes. In other words, the human eye perceives in the visually indistinguishable code a logo, an element, a symbol, a sequence of elements or the like, but cannot discern the information hidden in said code because such information is concealed by a composition of inks or materials having known electric properties and can only be read by using a suitable radio-frequency scanner comprising a decryption key specifically conceived for the application concerned.

Said visually indistinguishable code may also be hidden behind graphics, or laminated in the material layers and thus made invisible.

On the contrary, a visually distinguishable code is a code that can be discerned from another similar code through a simple visual examination, e.g. by reading a sequence of numbers, letters, alphanumeric, symbols, bars or other elements, or a magnetic sequence, a digital sequence stored in an RFID chip, or the like.

The information contained in a code is correlated to the electric properties of the inks used and to the sequence in which the latter have been printed, not to the general graphic appearance thereof.

By using at least one material having known electric properties, typically but not exclusively an ink, the user of the code generation system can generate a virtually infinite plurality of codes.

By way of example, the Applicant has developed inks and printing techniques which can generate code elements having well-defined electrically conductive behaviours: inks Z having non-conductive or insulating behaviours; inks A of the purely real type (in phase with the radio-frequency excitation signal); inks B of the purely imaginary type (out of phase by −90° with respect to the radio-frequency excitation signal); inks C of the mixed type (having a real component and an imaginary component, both non-null), obtainable by mixing together inks of the A and B types or through special formulations of said inks. A virtually infinite number of types of C-type inks can be created.

Referring now to FIG. 2, there is shown a graph representing the electric behaviour, in particular the conductance value Y, of a plurality of inks having calibrated electric properties when subjected to an alternating, or anyway variable, electric field.

The use of these inks having calibrated electric properties creates very stable electric behaviours of the elements of a code, and allows to develop software capable of interpreting sequences of elements forming the code even in the presence of very poor operating conditions or very degraded quality.

Furthermore, the coding can be made independent of the quantity of deposited ink, in that the code decrypting process may use both the variable of the absolute amplitude of the electric signal (meaning the amplitude of the real and imaginary components) and the ratio between the imaginary part and the real part of the signal.

The Applicant has also developed printing techniques that allow to control the electric properties of the elements, e.g. through application and/or ablation processes allowing to change the microstructure of a code element.

The following is required in order to generate an Item Code 50: the information to be encrypted (Item Information 10), the selected ink types (Z,A,B,C) having Electric Properties 30, and a univocal and original encryption key (General Key 20).

The Item Code 50 thus generated can be printed by using analog printing machines such as, for example, offset, flexographic, rotogravure, gravure and tampographic printing machines for non-serial printing, or digital printing machines such as, for example, inkjet printers, toner printers or thermal transfer systems for serial printing. In order to read the Item Code 50, it is necessary to use a radio-frequency scanner and to know the General Key 20 for extracting the information contained in the Item Code 50.

The Item Code 50 is read by swiping it through a suitable radio-frequency scanner, which returns information in real time about the authenticity of the Item Code 50 itself in addition to the information contained therein, possibly encrypted.

The authenticity of the Item Code 50 is expressed via a positive verification of the combination of inks having Electric Properties 30 (compared to the specified ones), the use of the correct decryption key, and the observance of a few logic rules.

The information contained in the Item Information 10 can be returned as an option, and may be useful for communicating with a database.

The Item Code 50 can be serialized, i.e. it can be printed on each unit with different information content, and can be printed by using serializable printing systems (digital printing).

However, although serialized printing is definitely feasible and industrialized, it may require significant industrial investments and know-how, in addition to considerable material and handling costs.

Moreover, although the Item Code 50 offers a high intrinsic level of protection, it has been observed that in some industrial applications additional security measures should be adopted to ensure a better control of the distribution chain of the Item Codes 50, so as to prevent any unauthorized use of pre-printed codes or distribution of excess printed codes.

By way of example, the manufacturer of Item Codes 50 (printer) may print Item Codes 50 in excess (or replicas of already printed ones) and then put them into circulation, even unintentionally. When checked, such Item Codes 50 would prove to be authentic: however, criminal organizations might use these Item Codes 50 to certify the authenticity of counterfeit goods or documents which are not. This problem is common to most anti-counterfeit systems used for protecting goods or documents.

It is therefore an object of the present invention to provide a method for coding and decoding information associated with an item, so as to generate a code ensuring a higher level of intrinsic security than prior-art codes.

It is another object of the present invention to provide a method for coding and decoding information associated with an item, such that the latter's authenticity can be established without making use of a database.

It is a further object of the present invention to provide a method for coding and decoding information associated with an item that can be used in various industrial applications, in particular whenever a serial number or the like is to be applied to the item.

It is a further object of the present invention to provide a method for coding and decoding information associated with an item, which allows to protect against fraudulent tampering the variable data applied to a security document such as, for example, a passport or an identity document.

It is yet another object of the present invention to provide a method for coding and decoding information associated with an item, which method requires low implementation costs.

These and other objects of the invention are achieved by the method for coding and decoding a code applicable to an item as claimed in the appended claims, which are intended to be an integral part of the present description.

In brief, the method according to the invention allows to obtain the same or, in some case, greater benefits than those attainable by printing a prior-art code, possibly a serialized one, through the use of inks having specific Electric Properties, while requiring very low investments on part of printers and packagers, or users of an item, at definitely competitive variable costs (cost per protected unit).

It is known that a universally recognized rule to increase the security of a system is to design security systems wherein each player is in possession of one element which is necessary, but not sufficient, to overcome a barrier.

The method of the present invention applies the above-mentioned principle, while also dividing the process of securing an item into two steps, i.e. a first step wherein a user A prints a code, and a second step wherein only a certified user B, who has the required computer credentials and detection tools, is allowed to use the information printed and encrypted by the user A to generate further information to be applied to the item.

This further encrypted information can be printed by using common serial marking systems such as, by way of example, inkjet, laser/toner, laser markers, thermal transfer films and the like, but can also be recorded on a magnetic or electronic medium.

The method of the present invention also allows an inspector to authenticate the code applied by the user A and to decrypt the encrypted information applied by the user B in the second step, thus allowing said encrypted information to be authenticated without interrogating a database.

Any cloned items can thus be locally and immediately found out, the authenticated information being possibly sent to a database.

The method of the present invention allows to protect a piece of information by means of a variable secret key contained in the item with which the protected information is associated. However, said secret key can only be used by authorized people in possession of suitable credentials and a scanner using proprietary technology. This ensures great variability of the protection key (e.g. it may vary in a unitary manner) without it having to be communicated to an inspector (user B), who will not even need a database to find it.

The invention will now be described in detail in some of its preferred embodiments, which are provided herein by way of non-limiting example, with reference to the annexed drawings, wherein:

FIG. 1 shows examples of codes applicable to an item, obtained through a plurality of inks having calibrated electric properties when subjected to an alternating, or anyway variable, electric field;

FIG. 2 shows a graph representing the electric behaviour of the inks of FIG. 1;

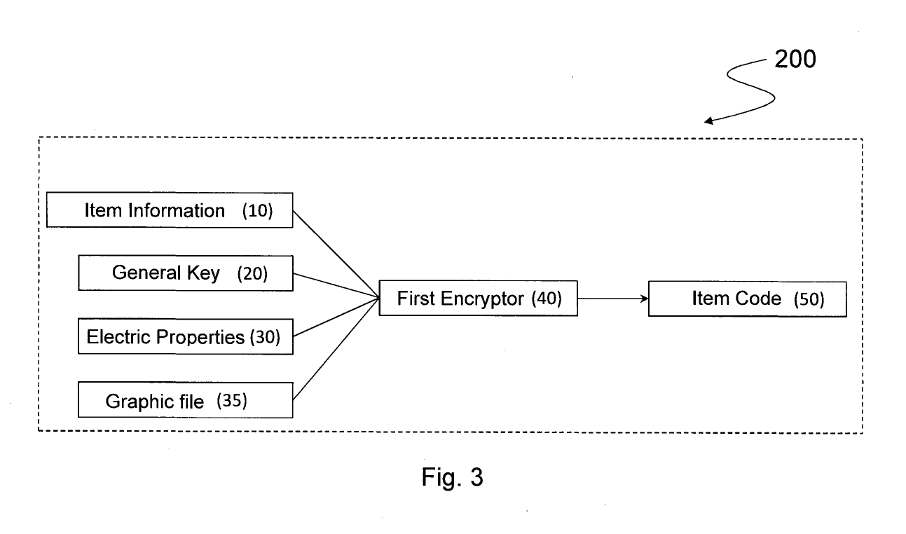

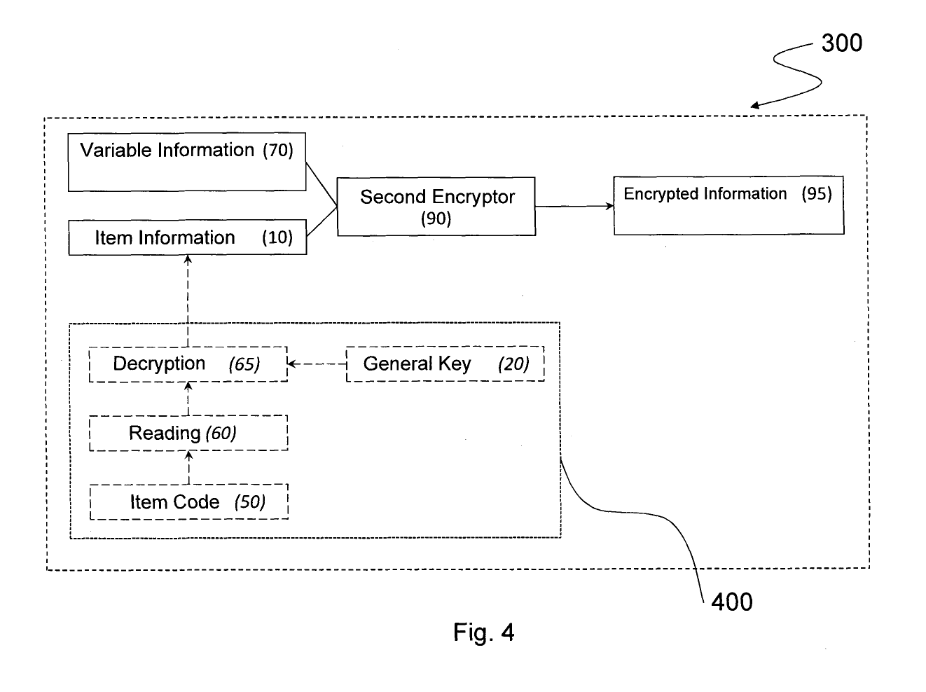

FIGS. 3 and 4 are block diagrams of a first and a second procedures of a coding method according to the invention;

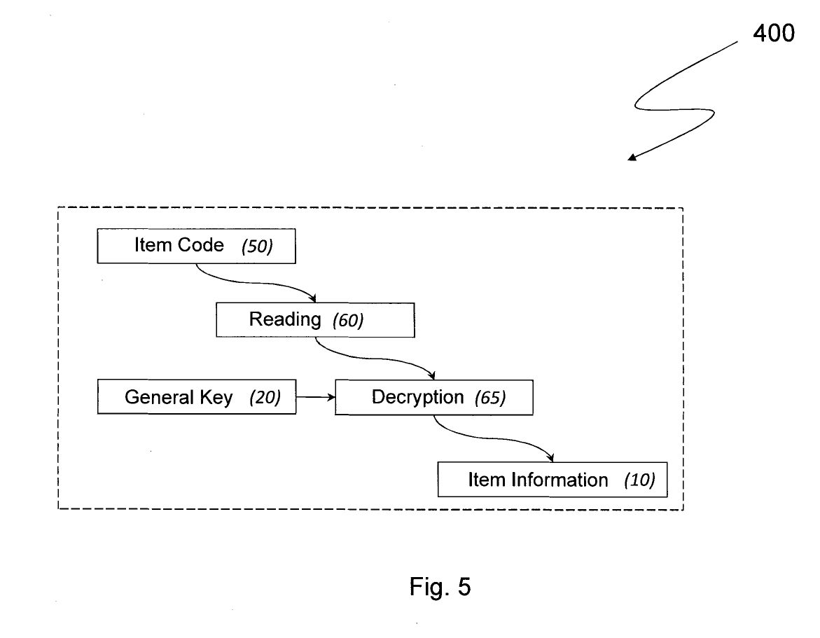

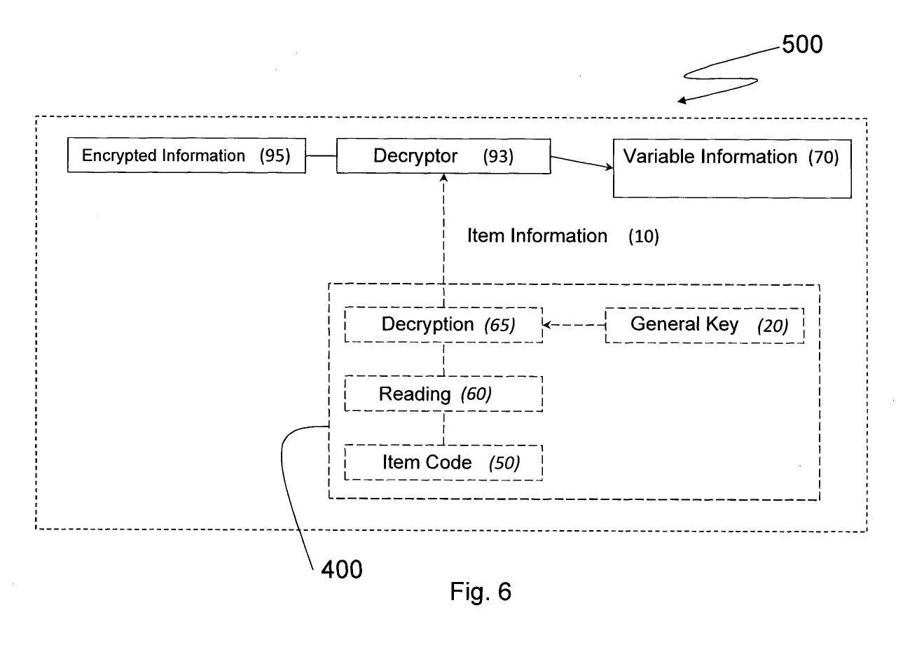

FIGS. 5 and 6 are block diagrams of a first and a second procedures of a decoding method according to the invention;

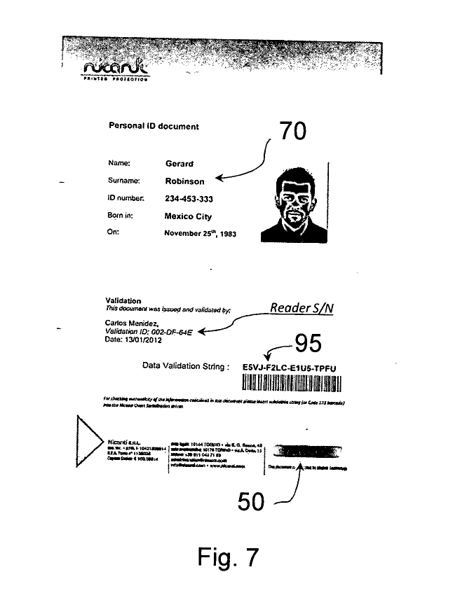

FIG. 7 shows an item, in particular a document, with which information coded in accordance with the invention is associated.

The method of the present invention includes a first and a second coding procedures 200,300 for coding information associated with an item, and a first and a second decoding procedures 400,500 for decoding the information associated with the item.

With reference to FIG. 3, the following will describe a first coding procedure 200.

A user A defines a piece of information called Item Information 10, or payload, which will be used for encrypting further information to be applied to a first item or to a second item associated with the first item, as will be further explained below.

The Item Information 10 typically comprises a digital string.

The user A also uses an encryption General Key 20 and selects the Electric Properties 30 of at least one ink, or another material, to be used for realizing the elements of the Item Code 50.

The Electric Properties 30 of the inks, or other materials, have been described with reference to FIG. 2.

The user A may also define a Graphic File 35, e.g. of the type shown in FIG. 1, which is used for representing the Item Code 50.

The data of the Item Information 10, the General Key 20, the at least one ink having Electric Properties 30, and possibly the Graphic File 35, are supplied to a First Encryptor 40, which outputs, for a given combination of said elements, the geometry to be used for realizing the Item Code 50, including the sequences according to which the various materials or inks having Electric Properties 30 must be applied into the geometry.

The Item Code 50 having said geometry is applied to a first item, e.g. through a printing process, taking care to apply the at least one ink, or other material, having Electric Properties 30 in the correct sequence, or position in the case of a single item, as defined by the geometry.

The Item Code 50 thus obtained is biunivocally correlated to the Item Information 10 through a secret encryption algorithm, used by the First Encryptor 40, and the General Key 20.

The Item Information 10 can only be extracted by executing a first decoding procedure 400, which will be described later on.

The size of the string of the Item Information 10 may very depending on the optimization required between the security and the physical dimension of the Item Code 50 that will subsequently be applied to the first item.

String sizes between 32 and 128 bits are typically chosen, without however any preclusion to the possibility of using shorter or longer strings.

The Item Information 10 may also vary as a function of the user's security needs: the higher the variability of the Item Information 10, the higher the security of the solution.

The highest level of security is attained by varying the Item Information 10 for each single item to be protected, with a string of theoretically infinite length.

With reference to FIG. 4, the following will describe a second coding procedure 300. In the second coding procedure 300, a user B (or the same user A) applies a piece of Encrypted Information 95 to the first item, or to a second item associable with the first item.

For example, the first item may be an article of clothing and the second item may be a label associable with the article of clothing; or the first item may be a banknote and the second item may be a security thread associable with the banknote.

In this respect, the user B defines a piece of Variable Information 70, which may be, by way of non-limiting example: a serial number, a random piece of information, a GPS localization, a digital map, audio/video sequences, a piece of information related to the validity of an item (e.g. the expiry date of a ticket), descriptive information of various kinds (e.g. a person's first name, surname and date of birth, in the case of a passport), or a graphic element (e.g. a digital photograph), or a piece of information describing the value of a money transaction.

If the Variable Information 70 contains too much data, it can be compressed by using standard data compression procedures or transformed into a checksum, e.g. a CRC (“Cyclic Redundancy Check”): in such a case, the Variable Information 70 will be the result of said compression.

A Second Encryptor 90 is given the Variable Information 70 and the Item Information 10 corresponding to the Item Code 50 previously applied to the first item, or to the second item associable with the first item, after the first coding procedure 200.

If the Item Information 10 is unknown to the user B (in most cases, in fact, the user B will be different from the user A), it can be extracted from the Item Code 50 through a first decoding procedure 400, which will be described later on.

The Second Encryptor 90 outputs a piece of Encrypted Information 95, typically an alphanumeric string, for each combination of Item Information 10 and Variable Information 70.

The Encrypted Information 95 may be either applied to the first item, or to the second item associable with the first item, through printing processes, or programmed on a magnetic, optical or electronic medium associable with or included in the first item, subject to a possible transformation (by way of non-limiting example, from a binary code into a base-10 or base-36 code, a barcode or a bidimensional code).

The result of the application of the first coding procedure 200 and of the second coding procedure 300 is an item (or an association of multiple items) whereto an Item Code 50, e.g. similar to the one shown in FIG. 1, and a piece of Encrypted Information 95, correlated to a piece of Variable Information 70 via a secret encryption algorithm and a General Key 20, have been applied.

The Variable Information 70 may be either applied or not to the item.

With reference to FIGS. 4 and 5, the following will describe a first decoding procedure 400 that can be used for extracting the Item Information 10 from the Item Code 50 when the Item Information 10 is unknown to the user who is extracting it.

According to the second decoding procedure 400, the user A or the user B, or an inspector, takes a Reading 60 of the Item Code 50 by using a suitable Reader of inks having specific Electric Properties 30, such as the one described in international patent application no. WO 2009/138571.

Subsequently, a Decryption algorithm 65, which is given the General Key 20 (or another key corresponding to the General Key 20, if asymmetric cryptography is used) by the same user, returns the Item Information 10.

The software used for the Decryption 65 may be so conceived as to not share the Item Information 10 with the user B and to keep such information stored in a memory of the processor of the Second Encryptor 90 for further procedures using said Item Information 10, such as, for example, those described in the second coding procedure 300.

The Item Code 50 is designed with such redundancy as to virtually exclude any significant probability of error in the first decoding procedure 400. Such a guarantee is necessary to avoid any incorrigible errors in the coding procedure 300.

What is obtained in the second coding procedure 300 can then be decoded and authenticated, and the resulting Variable Information 70 can be used for further authentication, tracing or other processes.

With reference to FIG. 6, in the second decoding procedure 500 an inspector supplies to a Decryptor 93 the Encrypted Information 95 applied to the item. The reading process may be optical, magnetic, electronic or of any other type suitable for information reading purposes. The process that supplies the Encrypted Information 95 to the Decryptor 93 may be either manual or automatic.

The Decryptor 93 is also given the Item Information 10 of the same item (or of an associated item). Said Item Key 10 must be extracted, since it is unknown to the inspector, from the Item Code 50 applied to the same item (or to the associated item) via the first decoding procedure 400.

The Decryptor 93 returns the Variable Information 70, which was originally encrypted in accordance with the second coding procedure 300.

The Variable Information 70 may be visually compared with other information printed on the item, e.g. with the same Variable Information 70 printed or stored on the item surface, or it may be sent to a database to verify its authenticity.

### First Variant

In addition to what has been stated in the above description of the second coding procedure 300, it is also possible to modify the Variable Information 70 in a manner such that it also contains, in addition to the original Variable Information 70, a piece of Additional Information, possibly entered automatically, which is useful for identifying a microprocessor of the Second Encryptor 90 (e.g. the serial number of the microprocessor or the serial number of the encryption software) and/or a piece of Further Information such as, for example, the encryption time and date and/or the name of the operator who has used the Second Encryptor 90. In such a case, the Variable Information 70 will be a combination of the initial Variable Information 70, the Additional Information and possibly the Further Information.

If said Additional Information is entered into the Variable Information 70 according to secret modalities and the latter is encrypted according to the second coding procedure 300, the Additional Information cannot be located in the Encrypted Information 95 unless one is in possession of a Reader for codes having specific Electric Properties 30, the decryption software and the General Key 20.

The use of the above allows an inspector to find any “system unfaithfulness” and to identify the Second Encryptor 90 that carried out the second coding procedure 300, possibly also identifying an unfaithful operator. This may happen, for example, when an unfaithful operator decides to use an authentic document containing an authentic Item Code 50 to create a final document with false variable data (Variable Information 70) (see Example 2 below).

### Second Variant

As a further addition or as an alternative to the above, it is conceivable to transform the Variable Information 70 into a checksum, typically a CRC code, and to add said checksum to the original Variable Information 70, so that said checksum becomes the Variable Information 70 in the second coding procedure 300. As aforesaid for the variant 1, since the Variable Information 70 is encrypted in accordance with the second coding procedure 300, it is impossible to recognize the presence of the checksum in the Encrypted Information 95.

At the end of the second decoding procedure 500 this addition allows to verify, even automatically, the authenticity of the Encrypted Information 95, the reliability of such verification depending on the type of checksum in use. The probability of not recognizing false items is of the order of magnitude of the inverse of 2 raised to the number of redundancy bits of the CRC (e.g. 32 bits of CRC correspond to a probability of not recognizing a false item every 10 billion decryptions).

Thanks to this addition, it is not necessary for the inspector to check the matching between the Variable Information 70 and other information printed on the item, in that there will be a very high probability of automatically recognizing a false or counterfeit Encrypted Information 95 even without comparing the Variable Information 70 resulting from the decryption process with said other information printed on the item. The fact that it is not necessary to make a comparison between the decrypted Variable Information 70 and other information printed on the item in order to confirm the authenticity of the Encrypted Information 95 implies two security advantages: (i) the decrypted Variable Information 70 needs not be made known to the inspector and (ii) the absence of Variable Information 70 shown in clear on the item prevents a counterfeiter from making any “reverse engineering” operations in an attempt to reconstruct the algorithms and/or encryption keys employed.

The above is advantageously possible without needing a connection to a database.

In brief, the above-described coding method allows to apply to an item a piece of Encrypted Information 95 which must be decoded by using the method described in the second decoding procedure 500.

When the above-described First and Second Variants are used, said Encrypted Information 95 can be authenticated automatically without knowing the Variable Information 70 contained therein.

Furthermore, if authentic Encrypted Information 95 is found, it is possible to have the Reader provide, still automatically, auxiliary information such as the serial number of the Second Encryptor 90 used for the second coding procedure 300.

The above is advantageously possible without needing a connection to a database, since all the information required for verifying the authenticity of the item has been directly written thereon.

It must be pointed out that, without the software for handling the secret algorithm of the First Encryptor 40, the General Key 20 and skills in the application of inks or other materials with controlled Electric Properties 30 (see FIG. 2), it will not be possible to generate an Item Code 50 and apply it to the item.

It must also be pointed out that, without a Reader for codes having specific Electric Properties 30 comprising Reading software 60 and Decryption software 65 provided with a General Key 20, it will not be possible to apply the second coding procedure 300 and therefore to apply Encrypted Information 95 to the item.

Finally, it must be emphasized that, without a Reader for codes having specific Electric Properties 30 comprising Reading software 60 and Decryption software 65 provided with a General Key 20, it will not be possible to apply the method described in the second decoding procedure 500 and therefore to decrypt the Encrypted Information 95.

A few examples of application of the coding and decoding method according to the present invention will now be illustrated.

### EXAMPLE 1

### Automatically Serialized Document

### User A:

An Item Code 50 is printed on a document, i.e. a first item, by means of a printing process using inks with controlled Electric Properties 30 in accordance with the first coding procedure 200.

The printing process is of the analog type (specifically Offset and Gravure).

The variability of the payload of the Item Code 50 is discrete, meaning that it varies regularly every given number of processed documents, i.e. in a way economically compatible with analog printing. The payload is a 40-bit binary string.

### User B:

A generator of sequential numbers produces numbers which are supplied to the Second Encryptor 90, which, for each sequential number entered, calculates a checksum, e.g. of the CRC16 type, and, by using a secret algorithm, combines the sequential number and its CRC16 besides the serial number of the processor of the Second Encryptor 90.

The result given by the Second Encryptor 90, typically a string, represents the Variable Information 70 to be used in the second coding procedure 300.

At the same time, the user B possessing the documents printed by the user A decodes the Item Code 50 printed on such documents by means of a Reader and the first decoding procedure 400.

The payload, i.e. the Item Information 10, resulting from the first decoding procedure 400 is then automatically stored into a memory of the processor of the Second Encryptor 90, which will use it in order to encrypt the Variable Information 70 for all the documents on which the Item Code 50 has been printed.

The Variable Information 70 is thus encrypted in the Second Encryptor 90 through a secret algorithm that uses, as an encryption key, the stored payload, i.e. the Item Information 10.

The result of the encryption process is a piece of Encrypted Information 95, which is then digitally printed on the documents, e.g. in base-36 format with a Code-128 barcode.

The Encrypted Information 95 is printed by continuous inkjet printing (CIJ) or toner printing.

The Encrypted Information 95 can only be decrypted by using the Item Code 50 printed on the document itself.

### Inspector:

For each document with the Item Code 50 and the Encrypted Information 95, an inspector carries out the second coding procedure 500, i.e.:
reads the Item Code 50 by means of a specific radio-frequency Reader previously provided with a General Key 20;
supplies to said Reader the Encrypted Information 95 printed on the same document.

A processor of said Reader applies the second decoding procedure 500 and returns information about:
the authenticity of the Item Code 50,
the authenticity of the Encrypted Information 95, and, if the above gives a positive outcome:
the serial number of the processor of the Second Encryptor 90 that carried out the encryption operation, and
the serial number of the document, i.e. the sequential information.

It should be noted that all the verification steps described so far are carried out without a connection to a database.

After having carried out these verification steps, the inspector may optionally interface to a database, possibly a remote one, in order to carry out further checks and/or event recording steps.

### EXAMPLE 2

### Document with Variable Data

### User A:

With reference to FIG. 7, an Item Code 50 is printed on a document, or first item, by means of a printing process using inks with controlled Electric Properties 30 in accordance with the first coding procedure 200.

The process for printing the Item Code 50 is digital (piezoelectric inkjet printing).

The variability of the Item Information 10 used for obtaining the Item Code 50 is unitary (unique Item Information 10 for each item) and random (generated by a generator of random information), for the purpose of improving the level of security.

The Item Information 10 is therefore comparable to a random serial number univocally identifying the document.

In this specific case, the Item Information 10 is a 96-bit binary string.

The document thus obtained is actually a module ready to receive the Variable Information 70, which may be protected by obtaining the Encrypted Information 95 in accordance with the second coding procedure 300. The Encrypted Information 95 is applied to the document while applying the Variable Information 70.

### User B: (Customization Step)

For each document, the user B reads the Item Code 50 by using a Reader and the first decoding procedure 400, thus extracting the payload, i.e. the Item Information 10.

Said payload is automatically stored (without being disclosed to the user) into the memory of the processor of the Second Encryptor 90. The binary content of said payload, i.e. the Item Information 10, is not made known to the user B.

The Variable Information 70 is then defined, which comprises the variable data to be printed on the document, such as Name, Surname, date and place of birth. Suitable software combines this variable information with a respective CRC 16 and with the serial number of the processor where the Second Encryptor 90 has been installed.

The Second Encryptor 90 encrypts the Variable Information 70 in order to return the Encrypted Information 95 valid for that specific customized document.

The Encrypted Information 95 is printed on the document, together with the Variable Information 70, as a QR code and is stored into an RFID chip included in the document.

The Encrypted Information 95 constitutes, in practice, both a variable-data validation string and a digital signature of the document.

### Inspector:

In order to authenticate the Encrypted Information 95 and extract therefrom the Variable Information 70, the inspector reads the QR code (or the RFID chip) and the Item Code 50 by using a Reader applying the second decoding procedure 500 (it should be reminded that the General Key 20 is required in order to read the Item Code 50).

The Reader will return information about:
the authenticity of the Item Code 50, i.e. of the module document;
optionally, the serial number of the document (equivalent to the Item Information 10);
the authenticity of the Encrypted Information 95,
   and, if the above gives a positive outcome:
the serial number of the Second Encryptor 90 that carried out the encryption operation,
optionally, the variable data of the document (equivalent to the Variable Information 70).

At this point, the inspector can ascertain the authenticity of the document, the correctness of the variable data, and the person who issued the document, in addition to being able to reconstruct the original variable data in the event that those originally printed on the document have been tampered with.

It is apparent that the step of comparing the calculated Variable Information 70 with the data printed on the document can be automated by using an optical scanner and OCR software.

It should be noted that all verification steps have been carried out so far without any connection to a database.

After having carried out these verification steps, the inspector may optionally interface to a database in order to carry out further checks and/or event recording steps.

Both of these cases highlight the advantages of the present invention, which allows to create, at variable costs and with very low specific investments, serialized documents (i.e. different from one another) that cannot be cloned and/or generated autonomously by unauthorized persons and without using the necessary tools. This is also true in the event that such persons should take possession without authorization of semi-finished documents, i.e. documents for which the first coding procedure 200 has been carried out.

Such documents are extremely difficult to counterfeit, because any forging of their data would be immediately identified during the verification stage.

A few counterfeit cases, which can be detected by applying the coding and decoding method according to the present invention, will now be illustrated.

a. Generation of a false item code 50:

This requires knowledge of the encryption logic, inks with known and not easily identifiable Electric Properties, knowledge of printing techniques, and a radio-frequency scanner. It is therefore extremely difficult to generate a false code.

b. Cloning an Item Code 50:

This requires sophisticated analytic tools and knowledge of the inks and printing techniques employed: the user controlling the Code may continually change the encryption rules, i.e. the Item Code, thus frustrating any attempts to copy the code by a counterfeiter.

c. Unauthorized use of authentic or cloned electronic codes (case wherein the counterfeiter does not have a reader of Item Codes 50)

It is possible that a printer (first user A) produces authentic Item Codes 50 in excess (which is unfortunately a widespread habit) or that, with less probability, a counterfeiter clones some Item Codes 50.

In such a case, the second user B using these items containing such codes should be in possession of a code reader with Reading 60 and Decryption 65 software, as well as the General Key 20.

In the absence of the reader and/or of the General Key 20, therefore, it will not be possible to generate Encrypted Information 95 that can be authenticated during the second decoding procedure 500.

If a counterfeiter is not in possession of the above tools, he will be compelled to apply Variable Information 95 de facto fabricated or cloned from other already protected items.

When verified, there will be a positive response to the authenticity check of the Item Code 50 (decoding procedure 400), but the response will not be positive to the second check (carried out according to the decoding procedure 500).

A necessary condition for the above to correspond to reality is that the Item Information 10 is varied regularly, and that there are no indications on the item as to what kind of Item Information has been applied.

From these considerations, it can be deduced that it would be virtually useless for a counterfeiter to take possession of production rejects and/or surplus.

d. Unauthorized use of authentic or cloned electronic codes (case wherein the counterfeiter has both the Reader and the General Key 20 for reading Item Codes 50) This case assumes that the second user B and the first user A have agreed to illicitly produce items with Item Codes 50, and that the second user B has a reader, proper credentials, and the General Key 20.

This is however a context that requires much organization.

In this case as well, even though an inspection will confirm the authenticity of the Item Code 50 and of the Encrypted Information 95, it will still be possible to discover the counterfeiter, i.e. the person who illicitly used the system, because the serial number of the Second Encryptor 90 will be known (see Second Variant).

The coding and decoding method of the present invention describes a physical and computer-based procedure for authenticating documents and goods without a connection to a database and for tracing any counterfeit operations in a simple and effective manner.

The coding and decoding method of the present invention further allows to generate and apply codes to innumerable types of items, while also allowing such codes to be used in an extremely wide range of applications.

For example, the code of the present invention may be used in order to: recognize counterfeit drugs, cosmetics, medical devices, foods, spare parts, articles of clothing; establish the authenticity of documents and receipts, and of variable data printed thereon; recognize counterfeit banknotes.

The features of the present invention, as well as the advantages thereof, are apparent from the above description.

A first advantage offered by a code generated in accordance with the method of the present invention is that it is extremely difficult to copy or clone.

A second advantage of a code coded and decoded in accordance with the method of the present invention is that the item is protected in two steps, i.e. (a) applying the optically indistinguishable Item Code 50, possibly hidden behind lamination layers, which can be done by using an analog or digital printing technique, followed by a step (b) of applying Encrypted Information 95, which may be carried out at a printing house or even directly on a manual or automatic packaging or document production line, by using serial application equipment available on the market such as, for example, continuous inkjet printers, laser printers, laser markers, ribbon transfer systems, thermosensitive printing.

Therefore, the user who applies the Encrypted Information 95 does not need to be equipped with special printing machines nor to purchase special inks or other consumables, and is not in possession of critical information as to the technology used for creating the Item Code 50.

A third advantage of the coding and decoding method according to the present invention is that the information contained in the Item Information 10 can be changed in a unitary manner, i.e. it can be serialized, and that the way it changes can be defined by the user.

A further advantage of the coding and decoding method according to the present invention is that it is possible to control who will use the method by supplying hardware, consumables for code application, and encryption General Keys 20.

A further advantage of the coding and decoding method according to the present invention is that the Variable Information can be applied onto a substrate in clear, so that the client's logistic handling will not be altered.

A further advantage of the coding and decoding method according to the present invention is that no connection to a database is required during both the item protection and authentication steps. This is very advantageous, especially during the decoding stage, because it allows the code of the present invention to be used in a large number of applications other than purely industrial ones, e.g. for recognizing false documents or goods in warehouses or places where no communication system is available, e.g. for drug authentication verification in depressed areas.

A further advantage of the coding and decoding method according to the present invention is that the Variable Information 70 obtained by decrypting the Encrypted Information 95 can be sent in encrypted form by the reader to a database for recording the event and other activities that can be carried out through a database.

A further advantage of a code coded and decoded in accordance with the method of the present invention is that the Item Code 50 can be changed randomly for each production lot, or even more often.

A further advantage of the coding and decoding method according to the present invention is that in the coding step it is possible to additionally and automatically code Additional Information to be added to the basic Variable Information. By also entering, at the coding stage, a piece of information relating to the Second Encryptor 90 that has carried out the coding operation, it will also be possible to establish the causes and responsibilities of any copying or improper use of said Encryptor.

A further advantage of the coding and decoding method according to the present invention is that it is possible to keep track of the exact number of pieces of Encrypted Information 95 generated, since such information must be generated by an algorithm code and proprietary software.

A further advantage of the coding and decoding method according to the present invention is that it is possible to speed up the process for protecting a document, in that within one same lot it is conceivable to use the same Item Code 50 for all documents whenever it is not absolutely necessary to ensure the utmost security, and that the equivalent Item Information 10 can remain stored in a processor of the Second Encryptor 90 during the entire print session.

A further advantage of the present invention is that the coding and decoding method of the present invention does not require the use of predefined Variable Information 70, since it can be easily integrated with an autonomous information generator.

A further advantage of the method according to the present invention is that the Item Code 50 can virtually be changed an infinite number of times without the inspector having to be informed, in that it is printed on the item (or on the associated item) on which the Encrypted Information 95 has been printed or applied. Since more variability of the Item Code 50 means more security, this implies that greater security can be achieved without increasing the complexity of the inspector's work.

A further advantage of the method according to the present invention is that the Item Code 50 can be hidden within the item, under graphic decoration layers or integrated into the item's graphics.

A further advantage of the method according to the present invention is that the General Key 20 can be supplied to the reader in encrypted form, thus only being operational on the reader for which it was created.

A further advantage of the method according to the present invention is that the General Key 20 can be changed for each type of application based on security requirements; therefore, the use of a standard Reader may be limited to reading predetermined Item Codes 50.

A further advantage of the method according to the present invention is that the Item Code 50 can be applied to a first item that will only subsequently be associated with a second item, whereto the Encrypted Information will be applied (e.g. label and document).

A further advantage of the method according to the present invention is that both the Decryption 93 and the Second Encryptor 90 software applications can be installed in the same processor of the same reader.

A further advantage of the method according to the present invention is that the Encrypted Information 95 as conceived in the Second Variant can be considered in all respects as a digital signature of a document, which cannot be easily modified.

The method for coding and decoding information associated with an item described herein by way of example may be subject to many possible variations without departing from the novelty spirit of the inventive idea; it is also clear that in the practical implementation of the invention the illustrated details may have different shapes or be replaced with other technically equivalent elements.

For example, the Variable Information 70 may be encrypted without reading and decrypting the Item Code 50 applied to the item, or to an item associated therewith, in that the Item Information 10 is already known from a previous decryption process carried out for a similar item. This may be the case when a production lot is subjected to the coding method, so that it will be sufficient to read the Item Information 10 from the first item of the lot and then use the same Item Information 10 for the remaining items of the lot.

It can therefore be easily understood that the present invention is not limited to a method for coding and decoding information associated with an item, but may be subject to many modifications, improvements or replacements of equivalent parts and elements without departing from the inventive idea, as clearly specified in the following claims.

1. A method for coding information associated with an item, comprising the steps of coding said information associated with said item through an encryption key and a first encryption algorithm, so as to generate a code associated with said information, said code being realized through at least one material having predefined electric properties and being readable and decryptable by applying a variable electric field, and of applying said code to said item, wherein encrypted information is generated which can be obtained by encrypting variable information through a second encryption algorithm which uses, as an encryption key, said information associated with said item, and in that said variable information is applied to said item or to a second item associated with said item.

2. The method according to claim 1, wherein said code is realized on the basis of a predefined graphic element.

3. The method according to claim 1, wherein said code is applied to said item through an analog or digital printing process.

4. The method according to claim 1, wherein said information associated with said item varies for each item, or for a predetermined number of items, to which said method is applied.

5. The method according to claim 1, wherein said variable information varies in a sequential or random manner.

6. The method according to claim 1, wherein said variable information comprises one or more of the following descriptive pieces of information: a serial number, a random piece of information, a GPS localization, a digital map, audio/video sequences, a piece of information related to the validity of an item, in particular to the expiry date thereof, personal data information, in particular a person's first name, surname and date of birth, a graphic element, in particular a photograph, a piece of information describing the value of a money transaction.

7. The method according to claim 6, wherein said variable information is obtained through a data compression of said descriptive information.

8. The method according to claim 7, wherein said variable information is formed by a combination of said variable information, a checksum and/or additional information defined either manually or automatically.

9. The method according to claim 1, wherein said encrypted information is associated with said item, or with a second item associated with said item, through a printing process.

10. The method according to claim 1, wherein said second item consists of a magnetic, optical or electronic medium and said encrypted information is stored therein.

11. The method according to claim 1, wherein said encrypted information is correlated to the serial number of a processor or another serial number of an encryptor using said second encryption algorithm or to an operator using said encryptor, so that said encrypted information can be considered to be equivalent to a digital signature.

12. The method according to claim 1, wherein said variable information is encrypted without reading and decrypting said code applied to said item, or item associated therewith, in that said information associated with said item is already known from a decryption process previously carried out for a similar item.

13. A method for decoding encrypted information associated with an item, comprising the steps of:
decoding a code associated with said item through a decryption key, so as to obtain information associated with said item, to be used as a decryption key of said encrypted information associated with said item, said code being realized through at least one material having predefined electric properties and being readable and decryptable by applying a variable electric field;
decoding said encrypted information applied to said item, or to a second item associated with said item, by decrypting said encrypted information into variable information through a decryption algorithm using, as a decryption key, said information associated with said item, previously extracted from said code.

14. The method according to claim 13, wherein said information associated with said item is not disclosed to the user during said decryption process.

15. The method according to claim 1, wherein the at least one material through which the code is realized comprises an ink.

16. The method accordingly to claim 13, wherein the at least one material through which the code is realized comprises an ink.
